(19) United States
(12) Patent Application Publication
(10) Pub. No.: US 2026/0214387 A1
(43) Pub. Date: Jul. 23, 2026

(54) HEAD-MOUNTED PLAYBACK DEVICE, AUDIO SYNCHRONIZED PLAYBACK METHOD AND AUDIO PLAYBACK SYSTEM

(71) Applicant: Bestechnic (Shanghai) Co., Ltd., Shanghai (CN)

(72) Inventors: Weifeng TONG, Shanghai (CN); Jun CHEN, Shanghai (CN)

(73) Assignee: Bestechnic (Shanghai) Co., Ltd., Shanghai (CN)

(21) Appl. No.: 19/433,471

(22) Filed: Dec. 26, 2025

Related U.S. Application Data
(63) Continuation of application No. PCT/CN2025/120455, filed on Sep. 10, 2025.

(30) Foreign Application Priority Data
Jan. 21, 2025 (CN) 202510091955.0

(51) Int. Cl. H04R 5/04; H04R 5/033; H04S 1/00

(52) U.S. Cl. CPC H04R 5/04; H04R 5/033; H04S 1/007; H04R 2420/07

(57) ABSTRACT

The head-mounted playback device includes a first component configured to playback left-channel audio content of audio data and a second component configured to playback right-channel audio content of the audio data. Each of the first component and the second component includes a controller including a counter circuit; a target wireless module including a receiving circuit and a trigger circuit; and a speaker. The receiving circuit is configured to: receive a wireless frame including clock synchronization information, and trigger the trigger circuit upon receiving the wireless frame. The trigger circuit, upon being triggered, is configured to: obtain a count value of the counter circuit, and output the count value to the controller. The controller is configured to control the speaker to play audio data in synchronization between playing the left-channel audio content and playing the right-channel audio content based on the synchronization adjustment.

### CROSS-REFERENCES TO RELATED APPLICATIONS

This application is a continuation of International Application No. PCT/CN2025/120455, filed on September 10, 2025, which claims the benefit of priority to Chinese Application No. 202510091955.0, filed on January 21, 2025, both of which are incorporated herein by reference in their entireties.

### TECHNICAL FIELD

The present disclosure relates to the field of wearable devices, and more specifically, relates to a head-mounted playback device, an audio synchronized playback method, and an audio playback system.

### BACKGROUND

Some audio playback systems simultaneously include an audio source device, a head-mounted playback device, and at least one other audio playback device, such as a speaker device. The audio data played by the audio source device may be played simultaneously through both the head-mounted playback device and the other audio playback device. For example, a mobile phone may simultaneously play music through a headset and a smart speaker.

There is a certain physical distance between the head-mounted playback device and the other audio playback device. In addition, the head-mounted playback device and the other audio playback device are different types of devices, each using different types of control chips, hardware circuits, and software programs. Due to these differences, a delay may occur when the head-mounted playback device and the other audio playback device respectively play the same audio data, resulting in unsynchronized playback that degrades the overall audio playback experience.

Currently, in some audio playback systems, different audio playback devices, including head-mounted playback devices and other audio playback devices, use the same clock synchronization protocol for clock synchronization. The clock synchronization accuracy of existing protocols is relatively low, and when the distance between different audio playback devices is relatively large, the system can tolerate lower clock synchronization accuracy without significantly affecting playback quality.

However, head-mounted playback devices typically include left and right components that are positioned close to each other, which imposes much higher requirements for clock synchronization accuracy. Existing clock synchronization protocols are generally inadequate to meet high synchronization accuracy demands of the head-mounted playback device. When the left and right components and other audio playback devices are synchronized using an existing clock synchronization protocol, playback of the audio data may become unsynchronized between the left and right components.

### SUMMARY

One aspect of the present disclosure provides a head-mounted playback device. The head-mounted playback device includes a first component configured to playback left-channel audio content of audio data and a second component configured to playback right-channel audio content of the audio data. Each of the first component and the second component includes a controller including a counter circuit, a target wireless module including a receiving circuit and a trigger circuit, and a speaker. The receiving circuit is configured to receive a wireless frame including clock synchronization information, and trigger the trigger circuit upon receiving the wireless frame. The trigger circuit, upon being triggered, is configured to obtain a count value of the counter circuit, and output the count value to the controller. The controller is configured to acquire audio data and the wireless frame, compare the count value of the counter circuit with the clock synchronization information included in the wireless frame, perform a synchronization adjustment based on a difference between the count value and the clock synchronization information, and control the speaker to play the audio data in synchronization between playing the left-channel audio content and playing the right-channel audio content based on the synchronization adjustment.

In some embodiments, the target wireless module is a Wi-Fi module, the wireless frame includes a Wi-Fi beacon frame, the clock synchronization information includes a timing synchronization function (TSF) value, and the receiving circuit includes a Wi-Fi beacon frame receiving sub-circuit configured to receive the Wi-Fi beacon frame, and trigger the trigger circuit upon receiving the Wi-Fi beacon frame.

In some embodiments, the controller includes a phase-locked loop circuit that is connected to the counter circuit, and controls playback of the audio data based on a clock signal output by the phase-locked loop circuit. The counter circuit performs counting based on the clock signal output by the phase-locked loop circuit. The phase-locked loop circuit is configured to compare the count value with the TSF value in the Wi-Fi beacon frame, and adjust the phase-locked loop circuit based on a difference between the count value and the TSF value, such that the clock signal output by the phase-locked loop circuit matches a clock signal of a device that sends the wireless frame.

In some embodiments, each controller of the first component and the second component is configured to control the speaker to play the audio data based on the count value of the counter circuit; and compare the count value with the TSF value of the Wi-Fi beacon frame, and adjust both a total value of the counter circuit and an accumulated value of the counter circuit per clock cycle based on the difference between the count value and the TSF value, such that the total value of the counter circuit matches the TSF value.

In some embodiments, the target wireless module is a Bluetooth module or a Wi-Fi module, and the first component and the second component are communicatively connected via Bluetooth or Wi-Fi. The receiving circuit includes a Bluetooth frame receiving sub-circuit, and the wireless frame includes a Bluetooth frame. The target wireless module of a target component is configured to receive the Bluetooth frame sent by a peer component via the Bluetooth frame receiving sub-circuit. Clock synchronization information in the Bluetooth frame sent by the peer component includes a peer count value of the peer component, where the target component is one of the first component or the second component, and the peer component is the other one of the first component or the second component. The controller of the target component is configured to: receive a target count value output by the target wireless module of the target component, compare the target count value with the peer count value, and perform playback control synchronization based on a difference between the target count value and the peer count value.

In some embodiments, the controller includes a phase-locked loop circuit connected to the target wireless module. The controller is configured to control playback of the audio data based on a clock signal output by the phase-locked loop circuit. The counter circuit is configured to count based on the clock signal output by the phase-locked loop circuit. The controller of the target component is configured to: adjust the phase-locked loop circuit based on the difference between the target count value and the peer count value, such that a clock signal output by the adjusted phase-locked loop circuit enables playback control synchronization between the target component and the peer component.

In some embodiments, the controller of the target component is configured to: adjust a playback timing of the audio data by the target component based on the difference between the target count value and the peer count value; and perform playback control synchronization between the target component and the peer component.

Another aspect of the present disclosure provides an audio playback system. The audio playback system includes a head-mounted playback device and at least one other audio playback device. The head-mounted playback device includes a first component configured to playback left-channel audio content of audio data and a second component configured to playback right-channel audio content of audio data. Each of the first component and the second component include a controller including a counter circuit, a target wireless module including a receiving circuit and a trigger circuit, and a speaker. The receiving circuit is configured to: receive a wireless frame including clock synchronization information from an audio source, and trigger the trigger circuit upon receiving the wireless frame. The trigger circuit, upon being triggered, is configured to obtain a count value of the counter circuit, and output the count value to the controller. Each controller of the first component or the second component is configured to: compare the count value of the counter circuit with the clock synchronization information included in the wireless frame received from the audio source; perform a synchronization adjustment based on a difference between the count value and the clock synchronization information; and control the speaker to play in synchronization between playing the left-channel audio content by the first component and playing the right-channel audio content by the second component based on the synchronization adjustment.

In some embodiments, at least one of the first component or the second component and the at least one other audio playback device are configured to perform synchronization based on a same clock synchronization protocol; and the at least one the first component or the second component and the at least one other audio playback device are configured to synchronously play the audio data based on a same synchronized clock.

In some embodiments, each controller of the first component or the second component is further configured to: determine, based on relative positions of the first component or the second component with respect to the at least one other audio playback device, a dynamic playback delay to be applied to playback timing of the speaker; and control the speaker to play audio data in dynamic synchronization with the at least one other audio playback device based on the synchronization adjustment and the dynamic playback delay.

In some embodiments, each controller of the first component or the second component is configured to maintain the dynamic synchronization by continuously or periodically adjusting the dynamic playback delay of the speaker in response to changes in the relative positions between the first component and the at least one other audio playback device or between the second component and the at least one other audio playback device.

In some embodiments, each controller of the first component or the second component is further configured to control the speaker playing the audio data after applying the dynamic playback delay. The dynamic playback delay corresponds to a transmission time for sound emitted by the at least one other audio playback device to reach a predetermined location associated with the head-mounted playback device, such that audio from both the head-mounted playback device and the at least one other audio playback device arrives at the user's ear substantially simultaneously.

In some embodiments, at least one of the first component or the second component is wirelessly connected to the at least one other audio playback device via the target wireless module. Each controller of the first component or the second component is configured to: perform measurement of a target distance between the first component and the at least one other audio playback device based on a wireless communication connection between the first component and the at least one other audio playback device, or perform measurement of a target distance between the second component and the at least one other audio playback device based on a wireless communication connection between the second component and the at least one other audio playback device; calculate the transmission time based on the target distance; and determine the dynamic playback delay based on the transmission time.

In some embodiments, the first component, the second component, or the at least one other audio playback device is connected to the audio source via a Digital Living Network Alliance (DLNA) protocol, an AirPlay protocol, or a Wi-Fi direct connection protocol.

In some embodiments, the target wireless module is a Wi-Fi module; the wireless frame includes a Wi-Fi beacon frame; the clock synchronization information includes a timing synchronization function (TSF) value; and the receiving circuit includes a Wi-Fi beacon frame receiving sub-circuit. The Wi-Fi beacon frame receiving sub-circuit is configured to receive the Wi-Fi beacon frame, and trigger the trigger circuit upon receiving the Wi-Fi beacon frame.

In some embodiments, the controller includes a phase-locked loop circuit that is connected to the counter circuit. The controller controls playback of the audio data based on a clock signal output by the phase-locked loop circuit. The counter circuit performs counting based on the clock signal output by the phase-locked loop circuit. The controller is configured to compare the count value with the TSF value in the Wi-Fi beacon frame, and adjust the phase-locked loop circuit based on a difference between the count value and the TSF value, such that the clock signal output by the phase-locked loop circuit matches a clock signal of the audio source that sends the wireless frame.

In some embodiments, each controller of the first component, the second component, or the at least one other audio playback device is configured to: control the speaker to play the audio data based on the count value of the counter circuit; and compare the count value with the TSF value of the Wi-Fi beacon frame, and adjust both a total value of the counter circuit and an accumulated value of the counter circuit per clock cycle based on the difference between the count value and the TSF value, such that the total value of the counter circuit matches the TSF value.

In some embodiments, the target wireless module is a Bluetooth module or a Wi-Fi module, and the first component and the second component are communicatively connected via Bluetooth or Wi-Fi. The receiving circuit includes a Bluetooth frame receiving sub-circuit, and the wireless frame includes a Bluetooth frame. The target wireless module of a target component is configured to receive the Bluetooth frame sent by a peer component via the Bluetooth frame receiving sub-circuit. Clock synchronization information in the Bluetooth frame sent by the peer component includes a peer count value of the peer component. The target component is one of the first component or the second component, and the peer component is the other one of the first component or the second component. The controller of the target component is configured to: receive a target count value output by the target wireless module of the target component, compare the target count value with the peer count value, and perform playback control synchronization based on a difference between the target count value and the peer count value.

In some embodiments, the audio playback system further includes a phase-locked loop circuit connected to the counter circuit and the target wireless module. The controller is configured to control playback of the audio data based on a clock signal output by the phase-locked loop circuit. The counter circuit is configured to count based on the clock signal output by the phase-locked loop circuit. The controller of the target component is configured to: adjust the phase-locked loop circuit based on the difference between the target count value and the peer count value, such that a clock signal output by the adjusted phase-locked loop circuit enables playback control synchronization between the target component and the peer component.

Yet another aspect of the present disclosure provides an audio playback system, including: an audio source device configured to provide audio data; a head-mounted playback device including a first component configured to playback left-channel audio content of the audio data and a second component configured to playback right-channel audio content of the audio data; and at least one other audio playback device. Each of the first component, the second component, and the at least one other audio playback device includes: a controller including a counter circuit; a WiFi module including a receiving circuit and a trigger circuit; and a speaker. The audio source device is configured to be communicatively connected to each of the first component, the second component, and the at least one other audio playback device via one of a Digital Living Network Alliance (DLNA) protocol, an Airplay protocol, or a WiFi direct protocol. Each of the first component, the second component, and the at least one other audio playback device is configured to receive the audio data from the audio source device via WiFi and to play the audio data. The receiving circuit of each of the first component, the second component, and the at least one other audio playback device is configured to receive a Wi-Fi beacon frame including a Time Synchronization Function (TSF) value, and to trigger the trigger circuit upon receipt of the Wi-Fi beacon frame. The trigger circuit, upon being triggered, is configured to obtain a count value from the counter circuit and output the count value to the controller. The controller of each of the first component, the second component, and the at least one other audio playback device is configured to: compare the count value of its counter circuit with the TSF value; adjust at least one of a total value of the counter circuit and an incremental value of the counter circuit per clock cycle, based on a difference between the count value and the TSF value; and control the speaker to play the audio data in synchronization with the at least one other audio playback device.

In some embodiments, the controller of the at least one of the first component or the second component is configured to maintain the synchronization by continuously or periodically adjusting a dynamic playback delay of the speaker in response to changing of the difference between the count value and the clock synchronization information.

Yet another aspect of the present disclosure provides a method for synchronizing audio playback in a head-mounted playback device. The head-mounted playback device includes a first component configured to playback left-channel audio content of audio data and a second component configured to playback right-channel audio content of the audio data. The method includes: receiving, by a receiving circuit of a target wireless module of each of the first component and the second component, a wireless frame including clock synchronization information; triggering, by the receiving circuit, a trigger circuit of the target wireless module in response to receiving the wireless frame; obtaining, by the trigger circuit of each of the first component and the second component, a count value of a counter circuit at a time corresponding to receiving the wireless frame, and outputting the count value to a controller; acquiring, by the controller of each of the first component and the second component, the audio data and the wireless frame; comparing, by the controller, the count value with the clock synchronization information included in the wireless frame; performing, by the controller, a synchronization adjustment based on a difference between the count value and the clock synchronization information; and controlling, by the controller of each of the first component and the second component, a respective speaker to play the audio data in synchronization between playing the left-channel audio content and playing the right-channel audio content based on the synchronization adjustment.

In some embodiments, the clock synchronization information included in the wireless frame includes a timing synchronization function (TSF) value. Receiving the wireless frame includes receiving a Wi-Fi beacon frame by a Wi-Fi module, and receiving the Wi-Fi beacon frame includes receiving, by a Wi-Fi beacon frame receiving sub-circuit, the Wi-Fi beacon frame and triggering the trigger circuit in response to receiving the Wi-Fi beacon frame.

In some embodiments, the controller includes a phase-locked loop circuit connected to the counter circuit, and the method further includes: controlling playback of the audio data based on a clock signal output by the phase-locked loop circuit; performing counting, by the counter circuit, based on the clock signal output by the phase-locked loop circuit; comparing, by the phase-locked loop circuit, the count value with the TSF value in the Wi-Fi beacon frame; and adjusting, by the phase-locked loop circuit, the output clock signal based on a difference between the count value and the TSF value, such that the output clock signal matches a clock signal of a device that sends the wireless frame.

In some embodiments, the method further includes: controlling, by each controller, the speaker to play the audio data based on the count value of the counter circuit; comparing, by each controller, the count value with the TSF value of the Wi-Fi beacon frame; and adjusting, by each controller, both a total value of the counter circuit and an accumulated value of the counter circuit per clock cycle based on the difference between the count value and the TSF value, such that the total value of the counter circuit matches the TSF value.

In some embodiments, the target wireless module is a Bluetooth module or a Wi-Fi module, and the first component and the second component are communicatively connected via Bluetooth or Wi-Fi; the receiving circuit includes a Bluetooth frame receiving sub-circuit; and the wireless frame includes a Bluetooth frame. The method further includes: receiving, by a target wireless module of a target component, the Bluetooth frame sent by a peer component via the Bluetooth frame receiving sub-circuit, where the target component is one of the first component or the second component, and the peer component is the other one of the first component or the second component, and clock synchronization information in the Bluetooth frame sent by the peer component includes a peer count value of the peer component; receiving, by a controller of the target component, a target count value output by the target wireless module of the target component; comparing, by the controller of the target component, the target count value with the peer count value; and adjusting, by the phase-locked loop circuit, the output clock signal based on a difference between the count value and the TSF value, such that the output clock signal matches a clock signal of a device that sends the wireless frame.

In some embodiments, the controller includes a phase-locked loop circuit connected to the target wireless module, and the method further includes: controlling playback of the audio data based on a clock signal output by the phase-locked loop circuit; counting, by the counter circuit, based on the clock signal output by the phase-locked loop circuit; and adjusting, by the controller of the target component, the phase-locked loop circuit based on a difference between the target count value and the peer count value, such that a clock signal output by the adjusted phase-locked loop circuit enables playback control synchronization between the target component and the peer component.

Yet another aspect of the present disclosure provides a method for synchronizing audio playback in an audio playback system. The audio playback system includes a head-mounted playback device and at least one other audio playback device. The head-mounted playback device includes a first component configured to playback left-channel audio content of audio data and a second component configured to playback right-channel audio content of the audio data. Each of the first component or the second component includes a controller having a counter circuit; a target wireless module having a receiving circuit and a trigger circuit; and a speaker. The method include: receiving, by the receiving circuit, a wireless frame including clock synchronization information from an audio source; triggering, by the receiving circuit, the trigger circuit in response to receiving the wireless frame; obtaining, by the trigger circuit, a count value of the counter circuit at a time corresponding to receiving the wireless frame, and outputting the count value to the controller; comparing, by the controller, the obtained count value with the clock synchronization information included in the wireless frame received from the audio source; performing, by the controller, a synchronization adjustment based on a difference between the count value and the clock synchronization information; and controlling, by the controller, the speaker to play in synchronization between playing the left-channel audio content by the first component and playing the right-channel audio content by the second component based on the synchronization adjustment. .

In some embodiments, performing the synchronization adjustment includes: performing, by at least one of the first component or the second component and the at least one other audio playback device, synchronization based on a same clock synchronization protocol, and the method further includes: synchronously playing, by at least one of the first component or the second component and the at least one other audio playback device, based on a same synchronized clock.

In some embodiments, the method further includes: determining, by the controller of at least one of the first component or the second component, a dynamic playback delay to be applied to playback timing of the speaker based on relative positions of the first component or the second component with respect to the at least one other audio playback device; and controlling, by at least one of the first component or the second component, the speaker to play audio data in dynamic synchronization with the at least one other audio playback device based on the synchronization adjustment and the dynamic playback delay.

In some embodiments, the method further includes: maintaining the dynamic synchronization by continuously or periodically adjusting, by the controller of at least one of the first component or the second component, the dynamic playback delay of the speaker of the first component or the second component in response to changes in the relative position of the first component or the second component with respect to the at least one other audio playback device.

In some embodiments, the method further includes: controlling, by the controller of at least one of the first component or the second component, the speaker to play the audio data after applying the dynamic playback delay, where the dynamic playback delay corresponds to a transmission time for sound emitted by the at least one other audio playback device to reach a predetermined location associated with the head-mounted playback device, such that audio from both the head-mounted playback device and the at least one other audio playback device arrives at a user's ear substantially simultaneously.

In some embodiments, the method further includes: wirelessly connecting at least one of the first component or the second component and the at least one other audio playback device; performing, by the controller of at least one of the first component or the second component, a measurement of a target distance between one of the first component or the second component and the at least one other audio playback device based on a wireless communication connection; calculating, by the controller, a transmission time based on the target distance; and determining, by the controller, the dynamic playback delay based on the transmission time.

In some embodiments, the at least one of the first component or the second component and the at least one other audio playback device are connected via a Digital Living Network Alliance (DLNA) protocol, an AirPlay protocol, or a Wi-Fi direct connection protocol.

### BRIEF DESCRIPTION OF THE DRAWINGS

The accompanying drawings, which are incorporated herein and form a part of the specification, illustrate aspects of the present disclosure and, together with the description, serve to explain the principles of the present disclosure and to enable a person skilled in the pertinent art to make and use the present disclosure.

FIG. 1 illustrates a schematic diagram of a head-mounted playback device including a first component and a second component according to some embodiments of the present disclosure.

FIG. 2. illustrates a schematic diagram of an audio playback system according to some embodiments of the present disclosure.

FIG. 3 illustrates a schematic diagram of an audio playback device according to some embodiments of the present disclosure.

FIG. 4 illustrates a flowchart of a method for synchronizing audio playback in a head-mounted playback device according to some embodiments of the present disclosure.

FIG. 5 illustrates a flowchart of a method for synchronizing audio playback in an audio playback system according to some embodiments of the present disclosure.

### DETAILED DESCRIPTION

To make the objectives, technical solutions, and advantages of the embodiments of the present disclosure more clearly understood, the present disclosure is described in detail below with reference to the accompanying drawings. It should be understood that the specific embodiments described herein are merely intended to illustrate the present disclosure and are not to be construed as limiting the present disclosure in any way.

An audio playback system usually includes an audio source device, a head-mounted playback device, and at least one speaker device. The head-mounted playback device includes left and right playback components. The audio source device sends audio data via a wireless module to the left and right playback components of the head-mounted playback device and to at least one speaker device. The left and right playback components and the at least one speaker device each include a processor, memory, a wireless module, and a speaker. The left and right playback components of the head-mounted playback device and the at least one speaker device receive the audio data and play it back through their respective speakers.

The head-mounted playback device may be a pair of true wireless earphones (especially open-ear earphones) or smart glasses. In the case of true wireless earphones, the left and right playback components correspond to the left and right earbuds, respectively. The audio source device may be a smartphone, tablet, laptop computer, or various other types of smart terminals. The at least one speaker device may include multiple speaker devices.

The audio data may be stereo, multichannel audio data, or mono audio data. The audio data sent by the audio source device to any of the audio playback devices, such as the left and right playback components of the head-mounted playback device or the at least one speaker device, may be stereo, multichannel audio data, a single channel of stereo audio, or a single channel of multichannel audio data.

Because the head-mounted playback device and the at least one speaker device are different devices, they often use different hardware, software, and master control chips. It is desirable to enable synchronized music playback between different playback devices, so the user hears spatial, expansive sound rather than disjointed, out-of-sync playback. Unsynchronized playback may result in an unstable or unnatural auditory experience, where the sound feels disjointed, chaotic, or uncoordinated.

For example, at least one of the left playback component and/or the right playback component, as well as other audio playback devices (e.g., the at least one speaker device), may be configured to perform clock synchronization based on a same clock synchronization protocol.

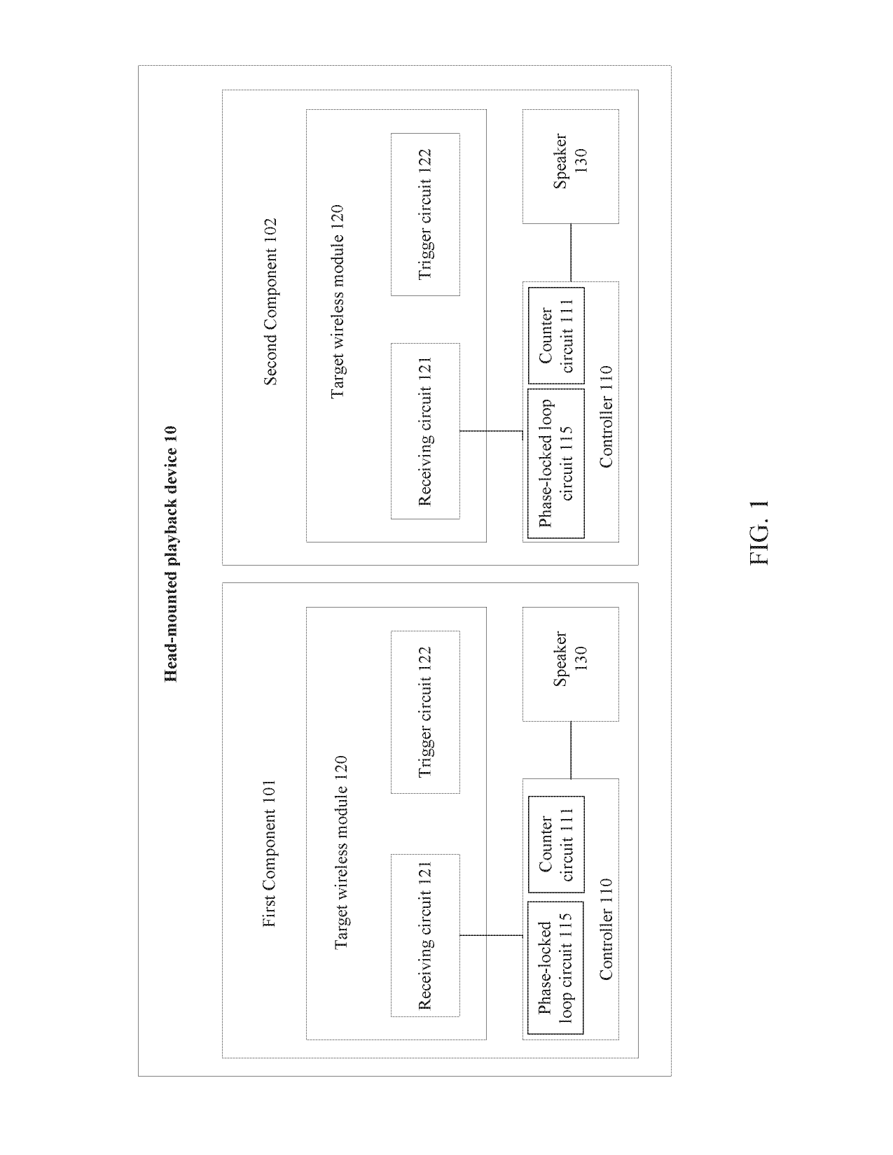

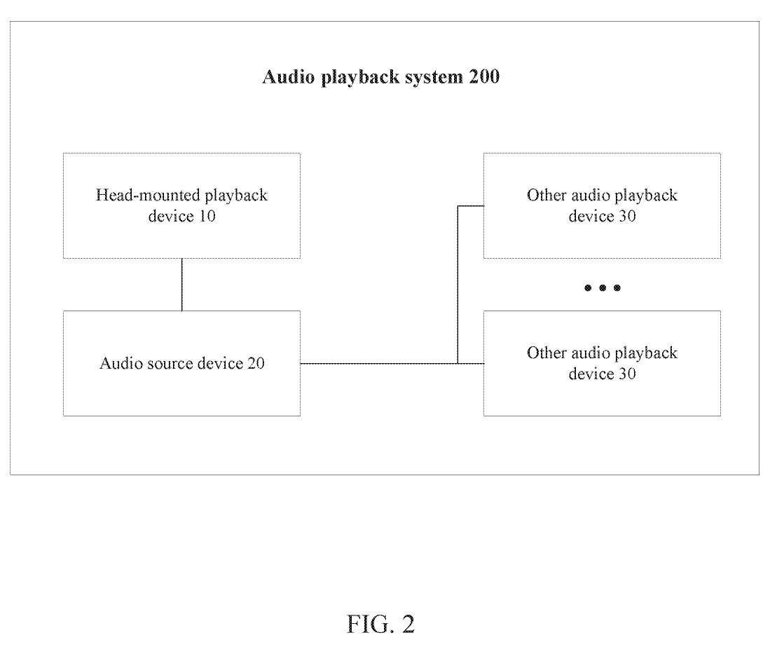

The clock synchronization protocol may be, for example, Network Time Protocol (NTP) or Precision Time Protocol (PTP). NTP is a network protocol used for synchronizing computer clocks and is capable of achieving millisecond-level time synchronization among different devices. Through NTP, all audio playback devices may be synchronized to a unified time reference, thereby ensuring consistency in audio playback. PTP is a protocol for achieving high-precision time synchronization among networked devices. In PTP-based systems, audio playback devices are connected to a same local area network (LAN), and one of the devices, such as the audio source device or one of the audio playback devices, is designated as the master clock device. PTP clients are configured on the other audio playback devices to receive timestamp information from the master clock and perform synchronization accordingly. The audio playback devices referenced herein include both the head-mounted playback device (e.g., the head-mounted playback device as shown in FIG. 1) and other audio playback devices (e.g., other audio playback devices as shown in FIG. 2).

The use of clock synchronization protocols such as NTP and PTP facilitates synchronized playback among audio playback devices across different devices, for example, synchronized playback between the head-mounted playback device and a speaker device. When synchronization is performed based on clock information recorded at the time when a controller of the head-mounted playback device sends or receives messages, there may be issues of limited synchronization accuracy and susceptibility to the performance of the controller. When the workload of controller is high, timely clock synchronization may not be achieved. In general, when the distances between different audio playback devices is relatively large (e.g., tens of centimeters), the accuracy requirement for cross-device playback synchronization is relatively low. Accordingly, clock synchronization performed using protocols such as NTP or PTP, based on clock information recorded when the controller sends or receives messages, may be sufficient for cross-device playback synchronization.

However, the head-mounted playback device usually has a compact size. That is, the distance between the right playback component and the left playback component is relatively small. When the head-mounted playback device is worn, the right playback component and the left playback component are worn on the user’s left and right ears, respectively, and the sound played by the speaker device is received by the user with minimal delay. As a result, any desynchronization in audio playback between the right playback component and the left playback component is more easily perceived by the user. Therefore, the head-mounted playback device requires higher clock synchronization precision, such as millisecond-level synchronization or even precision levels of 0.1 ms or 0.02 ms.

Accordingly, synchronized playback between the right playback component and the left playback component within the head-mounted playback device must achieve higher synchronization precision. However, existing clock synchronization protocols are inadequate to meet this requirement. Further improvements are required to enhance the clock synchronization precision between the right playback component and the left playback component of the head-mounted playback device.

In one aspect of the present disclosure, a head-mounted playback device is provided.

Referring to FIG. 1, which illustrates a schematic diagram of a head-mounted playback device including a first component and a second component according to some embodiments of the present disclosure. As shown in FIG. 1, the head-mounted playback device 10 includes a first component 101 configured to playback left-channel audio content of audio data and a second component 102 configured to playback right-channel audio content of the audio data. The head-mounted playback device 10 may be a true wireless earphone or a pair of smart glasses. When the head-mounted playback device 10 is a true wireless earphone, the first component 101 and the second component 102 may respectively correspond to a left earphone and a right earphone. When the head-mounted playback device 10 is a pair of smart glasses, the first component 101 and the second component 102 may respectively correspond to a left playback component and a right playback component on the smart glasses.

As shown in FIG. 1, each of the first component 101 and the second component 102 includes a controller 110, a target wireless module 120, and a speaker 130. Each of the first component 101 and the second component 102 may receive audio data to be played via the target wireless module 120, where the audio data is sent by an audio source device (such as the audio source device 20 as shown in FIG. 2). The controller 110 controls the speaker 130 to play the audio data.

In some embodiments of the present disclosure, the target wireless module 120 includes a receiving circuit 121 and a trigger circuit 122, and the controller 110 includes a counter circuit 111. The target wireless module 120 may be configured such that: the receiving circuit 121 receives a wireless frame including clock synchronization information and, upon receiving the wireless frame, triggers the trigger circuit 122. The trigger circuit 122, when triggered, obtains a current count value of the counter circuit 111 with the clock synchronization information included in the wireless frame and outputs the count value to the controller 110. The clock synchronization information may include a timing synchronization function (TSF) value. The controller 110 may acquire the audio data to be played and the wireless frame, compare the count value of the counter circuit 111 with the clock synchronization information included in the wireless frame, perform a synchronization adjustment based on a difference between the count value and the clock synchronization information, and control the speaker 130 to play the audio data in synchronization between playing the left-channel audio content and playing the right-channel audio content based on the synchronization adjustment.

In some embodiments, when the wireless frame is sent by the audio source device (such as the audio source device 20 as shown in FIG. 2) or a router device, the target wireless module 120 may be a Wi-Fi module, the wireless frame may include a Wi-Fi beacon frame, and the receiving circuit 121 may be a Wi-Fi beacon frame receiving sub-circuit. The first component 101 and the second component 102 may be communicatively connected to the audio source device or the router device via the Wi-Fi module and may receive the Wi-Fi beacon frame sent by the audio source device or the router device via the Wi-Fi beacon frame receiving sub-circuit. The Wi-Fi beacon frame receiving sub-circuit may trigger the trigger circuit 122 within the corresponding first component 101 or second component 102 after receiving the Wi-Fi beacon frame. Other circuits of the Wi-Fi module may refer to the related technology, and the target wireless module used in embodiments of the present disclosure may be implemented by configuring the receiving circuit and the trigger circuit based on an existing Wi-Fi module.

In addition, when the wireless frame is sent by the audio source device (e.g., the audio source device 20 as shown in FIG. 2), the audio data to be played may be carried in the wireless frame, i.e., the wireless frame may include both clock synchronization information and the audio data to be played.

The audio source device may simultaneously transmit the audio data to be played to the first component 101 and the second component 102. The audio data to be played may include music data, voice data, or other types of data.

In some embodiments, the audio data to be played may be stereo audio data, multichannel audio data, or monaural audio data. In some embodiments, the audio data transmitted by the audio source device (such as the audio source device 20 as shown in FIG. 2) to the first component 101 and the second component 102 of the head-mounted playback device 10, as well as to other audio playback devices (such as other audio playback devices 30 as shown in FIG. 2), may be stereo audio data, multichannel audio data, audio data of a single channel of the stereo audio data, or audio data of a single channel of the multichannel audio data.

When the audio data to be played is music data, the user may hear the music played by both the head-mounted playback device 10 and one or more of other audio playback devices (e.g., other audio playback devices 30 as shown in FIG. 2) at the same time, such that the overall audio experience has a greater sense of spatial depth and acoustic width, thereby providing the user with an enhanced listening experience.

In some embodiments, the first component 101 and the second component 102 may further include circuits, such as noise reduction circuits, or other devices, such as memory and sensors. The details of the circuits and other devices are not described herein to avoid redundancy.

In some embodiments of the present disclosure, each of the first component 101 and the second component 102 may include a phase-locked loop circuit 115, and the phase-locked loop circuit 115 may be arranged within the controller 110. Compared to software-based synchronization, the phase-locked loop circuit 115 is a hardware circuit capable of outputting more accurate and reliable clock signals. The controllers 110 of the first and second components may control audio data playback based on clock signals output by the phase-locked loop circuit 115, which helps improve synchronization precision and enhance playback accuracy.

In some embodiments of the present disclosure, in addition to the phase-locked loop circuit 115, the first component and the second component may also include other hardware circuits capable of outputting clock signals. For example, the target wireless module 120 may include a circuit configured to output a clock signal for controlling wireless frame reception. Such implementations are not limited herein. Hereinafter, the phase-locked loop circuit 115 refers to a circuit arranged within the controller.

In some embodiments of the present disclosure, the phase-locked loop circuit 115 is connected to the counter circuit 111. The controller 110 may control the playback of the audio data to be played based on a clock signal output by the phase-locked loop circuit 115, and the counter circuit 111 may count based on the clock signal output by the phase-locked loop circuit 115. In some embodiments, the phase-locked loop circuit 115 is configured to compare the count value with the TSF value in the Wi-Fi beacon frame, and adjust the phase-locked loop circuit based on a difference between the count value and the TSF value, such that the clock signal output by the phase-locked loop circuit matches a clock signal of a device that sends the wireless frame. In some embodiments, each controller 110 of the first component 101 and the second component 102 is configured to control the speaker 130 to play the audio data based on the count value of the counter circuit 111, compare the count value with the TSF value of the Wi-Fi beacon frame, and adjust both a total value of the counter circuit 111 and an accumulated value of the counter circuit 111 per clock cycle based on the difference between the count value and the TSF value, such that the total value of the counter circuit matches the TSF value.

One of the first component and the second component is designated as a target component, and the other one is designated as a peer component. In some embodiments, the wireless frame received by the target component is not limited to being transmitted from the audio source device (such as the audio source device 20 as shown in FIG. 2) or the peer component. When the first component and the second component are connected to a network, the wireless frame may also originate from a network-providing device, such as a router. In some embodiments, the target wireless module 120 is a Bluetooth module or a Wi-Fi module, and the first component 101 and the second component 102 may be communicatively connected via Bluetooth or Wi-Fi. The receiving circuit 121 may include a Bluetooth frame receiving sub-circuit, and the wireless frame may include a Bluetooth frame. The target wireless module 120 of the target component (one of the first or second component) is configured to receive the Bluetooth frame sent by the peer component (the other one of the first or second component) via the Bluetooth frame receiving sub-circuit. Clock synchronization information in the Bluetooth frame sent by the peer component includes a peer count value of the peer component. In some embodiments, the controller 110 of the target component is configured to receive a target count value output by the target wireless module 120 of the target component, compare the target count value with the peer count value, and perform playback control synchronization based on a difference between the target count value and the peer count value.

In some embodiments, the phase-locked loop circuit 115 may be connected to the target wireless module 120. The controller 110 may control playback of the audio data based on a clock signal output by the phase-locked loop circuit 115, and the counter circuit 111 may count based on the clock signal output by the phase-locked loop circuit 115. The controller 110 of the target component may adjust the phase-locked loop circuit 115 based on the difference between the target count value and the peer count value, such that a clock signal output by the adjusted phase-locked loop circuit enables playback control synchronization between the target component and the peer component.

In some embodiments, the controller 110 of the target component may adjust a playback timing of the audio data by the target component based on the difference between the target count value and the peer count value and perform playback control synchronization between the target component and the peer component.

In some embodiments, the receiving circuit 121, after receiving the wireless frame, may trigger the trigger circuit 122. The triggering may occur after receiving the frame header of the wireless frame, or after detecting a specific sequence or symbol within the wireless frame, or after receiving the entire wireless frame, or after a preset number of clock cycles following receipt of the wireless frame. No particular limitation is imposed herein.

According to some embodiments of the present disclosure, the receiving circuit 121, the trigger circuit 122, and the counter circuit 111 determine whether clock synchronization is required, without requiring the controller 110 to record this information through software execution. As a result, the processing load of the controller 110 may be prevented from increasing excessively, thereby reducing the burden on the controller 110 for enabling synchronization between the first component 101 and the second component 102. In addition, the receiving circuit 121, the trigger circuit 122, and the counter circuit 111 are all hardware circuits. Compared to software-based implementations, hardware circuits provide higher stability and accuracy and are not affected by the performance of the controller 110. Accordingly, the count value obtained is less likely to be subject to errors caused by the operational state of the controller 110, and thus a more accurate count value may be acquired, which contributes to improving synchronization precision.

Additionally, compared to clock synchronization protocols, the count value output by hardware circuits offers higher precision. Therefore, after clock synchronization is performed between the first component 101 and the second component 102 of the head-mounted playback device 10 and other audio playback devices (e.g., other audio playback devices 30 as shown in FIG. 2) based on a synchronization protocol, the first component 101 and the second component 102 may further perform clock synchronization based on the count value. This effectively achieves a second level of synchronization within a narrower precision range. For example, while the original synchronization protocol may provide a synchronization precision of 1 ms, subsequent synchronization based on the count value may achieve precision levels such as 0.1 ms or 0.02 ms. As a result, clock synchronization based on the count value does not negatively affect the synchronized playback between the first component 101, the second component 102, and the other audio playback devices. Rather, it enhances synchronized playback of the first component 101 and the second component 102 within the head-mounted playback device 10, thereby improving overall playback performance.

In some embodiments, the first component 101 and the second component 102 may be communicatively connected to the audio source device (e.g., the audio source device 20 as shown in FIG. 2) via DLNA (Digital Living Network Alliance), Airplay (a wireless streaming protocol for audio, video, or photos), or a Wi-Fi direct connection protocol. No particular limitation is imposed herein.

In some embodiments, when the wireless frame includes a Wi-Fi beacon frame, the clock synchronization information may be a Time Synchronization Function (TSF) value included in the Wi-Fi beacon frame.

In some embodiments, the controllers 110 of both the first component 101 and the second component 102 may be configured to: compare the count value with the TSF value in the Wi-Fi beacon frame; and, adjust, when the count value and the TSF value indicate that the clocks are not synchronized, the phase-locked loop circuit 115 based on a difference between the count value and the TSF value, such that the clock signal output by the phase-locked loop circuit 115 matches a clock signal of the device that sends the wireless frame.

The counter circuit 111 may perform counting based on a clock signal output by the phase-locked loop circuit 115, and the TSF value may also be based on a count value generated by a counter of the audio source device or the router device. Therefore, the count value and the TSF value may be directly compared to determine whether the count value and the TSF value match, and thereby determine whether the clocks are synchronized. Compared with comparing clock signals, comparing the count value with the TSF value may improve comparison efficiency and reduce power consumption required to determine clock synchronization. The term “match” may refer to the count value and the TSF value being equal, or to the difference between the count value and the TSF value being within a predetermined threshold, which is not limited herein.

By comparing the count value with the TSF value, it may be determined whether the clock signal output by the phase-locked loop circuit 115 of the first component 101 or the second component 102 is synchronized. When the clock signals are not synchronized, the phase-locked loop circuit 115 may be adjusted such that the output clock signal outputted by the phase- locked loop circuit 115 accelerates or decelerates the counting of the counter circuit 111, until the counter circuit 111 matches the TSF value in the Wi-Fi beacon frame, thereby achieving synchronization between the clock signal output by the phase-locked loop circuit 115 and the TSF value in the Wi-Fi beacon frame. The methods for adjusting the phase-locked loop circuit 115 to change the output clock signal may refer to conventional techniques and is not described in detail herein.

In some embodiments, the counter circuit 111 performs counting based on a clock signal generated by the first component 101 or the second component 102, and the count value of the counter circuit 111 may be used to characterize the clock signal. Therefore, the controllers 110 of the first component 101 and the second component 102 may be configured not to control the playback of the audio data based on the clock signal output by the phase-locked loop circuit 115, but instead to control the speaker 130 to play the audio data to be played based on the count value of the counter circuit 111.

In some embodiments, the controller 110 may further be configured to: compare the count value with the TSF value of the Wi-Fi beacon frame; and when the count value and the TSF value indicate that the clocks are not synchronized, adjust both a total value of the counter circuit 111 and an accumulated value of the counter circuit 111 per clock cycle based on a difference between the count value and the TSF value as clock synchronization information, such that the total value of the counter circuit 111 matches the TSF value, thereby ensuring that the clock signal characterized by the count value output by the counter circuit 111 matches the clock signal characterized by the TSF value.

The term “match” refers to the count value and the TSF value being identical or having a difference within a predetermined threshold. When the count value and the TSF value indicate that the clocks are not synchronized, the count value and the TSF value are considered not to match. In some embodiments, adjusting the total value of the counter circuit 111 based on the difference between the count value and the TSF value as clock synchronization information may include: calculating a difference between the current count value acquired by the trigger circuit 122 and the TSF value, and then adding the corresponding difference to the total value of the counter circuit 111. This approach does not require adjustment of the phase-locked loop circuit 115 that outputs the clock signal, thereby further reducing implementation complexity and lowering power consumption.

In some embodiments, the wireless frame may also be transmitted between the first component 101 and the second component 102. That is, the first component 101 may transmit a wireless frame to the second component 102, or the second component 102 may transmit a wireless frame to the first component 101. This approach is performed by establishing a communication connection between the first component 101 and the second component 102.

In some embodiments, the target wireless module 120 is a Bluetooth module or a Wi-Fi module, and the first component 101 and the second component 102 may be communicatively connected via Bluetooth or Wi-Fi. The receiving circuit 121 may include a Bluetooth frame receiving sub-circuit, and the wireless frame may include a Bluetooth frame.

The target wireless module 120 of the target component may be configured to receive the Bluetooth frame transmitted by the peer component through the Bluetooth frame receiving sub-circuit. Clock synchronization information included in the Bluetooth frame transmitted by the peer component may include a peer count value of the peer component. The controller 110 of the target component may be configured to: receive a target count value output by the target wireless module 120 of the target component; compare the target count value with the peer count value; and perform playback control synchronization adjustment based on a difference between the target count value and the peer count value. Here, one of the first component 101 or the second component 102 serves as the target component, and the other one serves as the peer component. The peer component may transmit its own count value to the target component, such that the target component is synchronized with the peer component.

In some embodiments, synchronization may be achieved by adjusting the clock signal output by the phase-locked loop circuit 115. For example, the controller 110 of the target component may be configured to adjust the phase-locked loop circuit 115 based on a difference between the target count value and the peer count value, so as to synchronize the playback control of the target component with that of the peer component.

In some embodiment, the controller 110 of the target component may further be configured to adjust a playback timing of the audio data to be played by the target component based on the difference between the target count value and the peer count value, so as to synchronize the playback control of the target component with the playback control of the peer component.

The audio data to be played may first be stored in a buffer and then output from the buffer to the speaker 130 for playback. In some embodiments, the amount of data stored in the buffer may be adjusted so as to adjust the playback timing of the audio data to be played.

The above-mentioned synchronization are merely examples provided by the present disclosure. Different synchronization manners may be selected in different scenarios without limitation.

Another aspect of the present disclosure provides an audio playback system. Referring to FIG. 2, which is a schematic diagram of the audio playback system according to some embodiments of the present disclosure. As shown in FIG. 2, the audio playback system 200 includes: head-mounted playback device 10 and audio source device 20 that are communicatively connected with each other.

The audio source device 20 is configured to provide audio data to be played. The audio source device 20 may be a mobile phone, tablet, laptop, or other types of smart terminals.

The head-mounted playback device 10 may be any of the head-mounted playback device described in the foregoing embodiments (e.g., head-mounted playback device as shown in FIG. 1). The head-mounted playback device 10 is configured to receive the audio data to be played and wireless frames, and to perform playback control synchronization adjustment based on clock synchronization information contained in the wireless frames. For specific functions, reference may be made to the previously described head-mounted playback device 10.

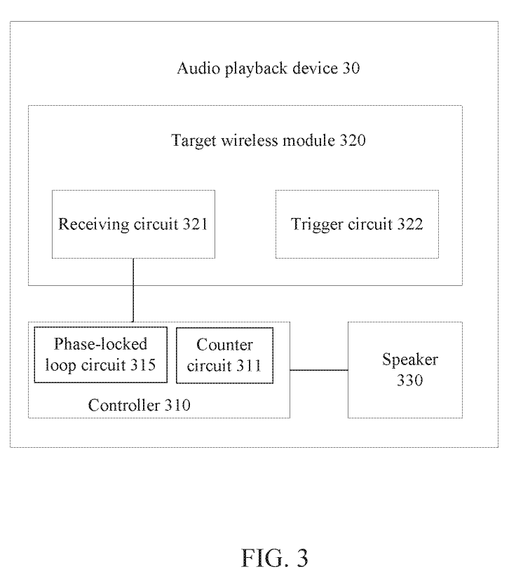

In some embodiments, the audio playback system 200 may further include: one or more other audio playback devices 30 (e.g., audio playback device as shown in FIG. 3), which are communicatively connected to the audio source device 20. The one or more other audio playback devices 30 and the head-mounted playback device 10 may perform clock synchronization based on a same clock synchronization protocol.

Referring back to FIG. 1, the head-mounted playback device 10 includes a first component 101 configured to playback left-channel audio content of audio data and a second component 102 configured to playback right-channel audio content of the audio data. The head-mounted playback device 10 may be a true wireless earphone or a pair of smart glasses. When the head-mounted playback device 10 is a true wireless earphone, the first component 101 and the second component 102 may respectively correspond to a left earphone and a right earphone. When the head-mounted playback device 10 is a pair of smart glasses, the first component 101 and the second component 102 may respectively correspond to a left playback component and a right playback component on the smart glasses.

As shown in FIG. 1, each of the first component 101 and the second component 102 includes a controller 110, a target wireless module 120, and a speaker 130. Each of the first component 101 and the second component 102 may receive audio data to be played via the target wireless module 120, where the audio data may be sent by the audio source device 20 as shown in FIG. 2. The controller 110 controls the speaker 130 to play the audio data.

As shown in FIG. 3, each of the at least one other playback device 30 may include a controller 310, a target wireless module 320, and a speaker 330. The audio playback device 30 may receive audio data to be played via the target wireless module 320, where the audio data may be sent by the audio source device 20 as shown in FIG. 2. The controller 310 controls the speaker 330 to play the audio data. The controller 310 may include a phase-locked loop circuit 315 and a counter circuit 311. The target wireless module 320 is a Bluetooth module or a Wi-Fi module (or other modules that enable wireless communication), which includes a receiving circuit 321 and a trigger circuit 322.

The audio source device may simultaneously transmit the audio data to be played to the first component 101, the second component 102, and the at least one other playback device. The audio data to be played may include music data, voice data, or other types of data.

In some embodiments, the audio data to be played may be stereo audio data, multichannel audio data, or monaural audio data. In some embodiments, the audio data transmitted by the audio source device 20 to the first component 101 and the second component 102 of the head-mounted playback device 10, as well as to other audio playback devices 30 as shown in FIG. 2, may be stereo audio data, multichannel audio data, audio data of a single channel of the stereo audio data, or audio data of a single channel of the multichannel audio data.

When the audio data to be played is music data, the user may hear the music played by both the head-mounted playback device 10 and one or more of other audio playback devices (e.g., other audio playback devices 30 as shown in FIG. 2) at the same time, such that the overall audio experience has a greater sense of spatial depth and acoustic width, thereby providing the user with an enhanced listening experience.

In some embodiments of the present disclosure, referring back to FIG. 1, the target wireless module 120 includes a receiving circuit 121 and a trigger circuit 122, and the controller 110 includes a counter circuit 111. The target wireless module 120 may be configured such that the receiving circuit 121 receives a wireless frame including clock synchronization information from the audio source device 20. Upon receiving the wireless frame, the receiving circuit 121 triggers the trigger circuit 122. The trigger circuit 122, when triggered, obtains a current count value of the counter circuit 111 with the clock synchronization information included in the wireless frame and outputs the count value to the controller 110. The clock synchronization information may include a timing synchronization function (TSF) value. The controller 110 of the first component 101 and/or the second component 102 is configured to: compare the count value of the counter circuit 111 with the clock synchronization information included in the wireless frame received from the audio source device 20, perform a synchronization adjustment based on a difference between the count value and the clock synchronization information.

In some embodiments, at least one of the first component 101 or the second component 102 and the at least one other audio playback device 30 are configured to perform synchronization based on a same clock synchronization protocol. The at least one the first component 101 or the second component 102 and the at least one other audio playback device 30 are configured to synchronously play audio data based on a same synchronized clock.

In some embodiments, the synchronization mechanism employed by the at least one other audio playback device 30 may be the same as the synchronization mechanism implemented by the first component 101 and/or the second component 102, since the at least one other audio playback device 30 includes similar components, such as a trigger circuit, a counter circuit, a controller, etc. Accordingly, the at least one other audio playback device 30 is capable of achieving synchronized playback with the first component 101 and/or the second component 102 based on the same synchronization protocol or mechanism.

In some embodiments, each controller 110 of the first component and/or the second component 102 is further configured to determine, based on relative positions of the first component 101 or the second component 102 with respect to the at least one other audio playback device 30, a dynamic playback delay to be applied to playback timing of the speaker 130, and control the speaker 130 to play audio data in dynamic synchronization with the at least one other audio playback device 30 based on the synchronization adjustment and the dynamic playback delay.

In some embodiments, each controller 110 of the first component 101 and/or the second component 102 is configured to maintain the dynamic synchronization by continuously or periodically adjusting the dynamic playback delay of the speaker 130 in response to changes in the relative positions between of the first component 101 or the second component 102 and the at least one other audio playback device 30.

In some embodiments, each controller 110 of the first component 101 and/or the second component 102 is configured to control the speaker 130 to playback the audio data after applying the dynamic playback delay. The dynamic playback delay corresponds to a transmission time for sound emitted by the at least one other audio playback device 30 to reach a predetermined location associated with the head-mounted playback device 10. For example, when the head-mounted playback device 10 is worn by a user, its position closely corresponds to the position of the user’s ears. The controller 110 may utilize signals exchanged between the head-mounted playback device 10 and the at least one other audio playback device 30 to measure the distance between the head-mounted playback device 10 and the at least one other audio playback device 30. The controller 110 may then dynamically adjust the playback delay in response to changes in the user’s location, such as when the user moves within an environment, thereby ensuring that the audio from the first component 101, the second component 102, and the at least one other audio playback device 30 to arrive at the user's ear substantially simultaneously regardless of user movement or changes in the relative position of the devices.

In some embodiments, at least one of the first component 101 or the second component 102 and the at least one other audio playback device 30are wirelessly connected to the audio source device 20 via the target wireless module 120 (or 320). In some embodiments, the controller 110 of at least one of the first component 101 or the second component 102 performs measurement of a target distance between one of the first component 101 or the second component 102 and the at least one other audio playback device 30 based on a wireless communication connection between one of the first component 101 or the second component 102 and the at least one other audio playback device 30. The controller 110 of at least one of the first component 101 or the second component 102 then calculates the transmission time based on the target distance and determines the dynamic playback delay based on the transmission time.

The at least one of the first component 101 or the second component 102 and the at least one other audio playback device 30 may be connected to the audio source device 20 via a Digital Living Network Alliance (DLNA) protocol, an AirPlay protocol, or a Wi-Fi direct connection protocol.

In some embodiments, the target wireless module 120 is a Wi-Fi module, the wireless frame includes a Wi-Fi beacon frame, the clock synchronization information includes a timing synchronization function (TSF) value, and the receiving circuit 121 includes a Wi-Fi beacon frame receiving sub-circuit, where the Wi-Fi beacon frame receiving sub-circuit is configured to receive the Wi-Fi beacon frame, and trigger the trigger circuit 122 upon receiving the Wi-Fi beacon frame.

In some embodiments, the first component 101, the second component 102, and the at least one other playback device may further include circuits, such as noise reduction circuits, or other devices, such as memory and sensors. The details of the circuits and other devices are not described herein to avoid redundancy.

In some embodiments of the present disclosure, each of the first component 101 and the second component 102 may include a phase-locked loop circuit 115, and the phase-locked loop circuit 115 may be arranged within the controller 110. Compared to software-based synchronization, the phase-locked loop circuit 115 is a hardware circuit capable of outputting more accurate and reliable clock signals. The controllers 110 of the first and second components may control audio data playback based on clock signals output by the phase-locked loop circuit 115, which helps improve synchronization precision and enhance playback accuracy. In some embodiments, each of the at least one other playback device 30 may also include a phase-locked loop circuit 315 inside the controller 310.

In some embodiments, the phase-locked loop circuit 115 is connected to the counter circuit 111, and the controller 110 controls playback of the audio data based on a clock signal output by the phase-locked loop circuit 115. The counter circuit 111 performs counting based on the clock signal output by the phase-locked loop circuit 115. The phase-locked loop circuit 115 is configured to compare the count value with the TSF value in the Wi-Fi beacon frame, and adjust the phase-locked loop circuit based on a difference between the count value and the TSF value, such that the clock signal output by the phase-locked loop circuit 115 matches a clock signal of the at least one other audio playback device 30 that sends the wireless frame. The phase-locked loop circuit 315 acts similarly to the phase-locked loop circuit 115, which is not repeated herein.

In some embodiments, each controller of the first component 101, the second component 102, and the at least one other playback device 30 is configured to control their respective speaker to play the audio data based on the count value of their respective counter circuit (111 as shown in FIG. 1 or 310 as shown in FIG. 3), compare the count value with the TSF value of the Wi-Fi beacon frame, and adjust both a total value of the counter circuit 111 or 310 and an accumulated value of the counter circuit 111 or 311 per clock cycle based on the difference between the count value and the TSF value, such that the total value of the counter circuit matches the TSF value.

In some embodiments, the target wireless module 120 includes a Bluetooth module, a Wi-Fi module, or other modules that enable wireless communications. For example, the first component 101 and the second component 102 are communicatively connected via Bluetooth or Wi-Fi. The receiving circuit 121 includes a Bluetooth frame receiving sub-circuit, and the wireless frame includes a Bluetooth frame. The target wireless module 120 of a target component is configured to receive the Bluetooth frame sent by a peer component via the Bluetooth frame receiving sub-circuit. Clock synchronization information in the Bluetooth frame sent by the peer component includes a peer count value of the peer component. The target component is one of the first component 101 or the second component 102, and the peer component is the other one of the first component 101 or the second component 102. The controller of the target component is configured to: receive a target count value output by the target wireless module 120 of the target component, compare the target count value with the peer count value, and perform playback control synchronization based on a difference between the target count value and the peer count value.

In some embodiments, the phase-locked loop circuit 115 is connected to the counter circuit 111 and the target wireless module 120. The controller 110 is configured to control playback of the audio data based on a clock signal output by the phase-locked loop circuit 115. The counter circuit 111 is configured to count based on the clock signal output by the phase-locked loop circuit 115. The controller 110 of the target component is configured to adjust the phase-locked loop circuit 115 based on the difference between the target count value and the peer count value, such that a clock signal output by the adjusted phase-locked loop circuit enables playback control synchronization between the target component and the peer component.

In some embodiments of the present disclosure, in addition to the phase-locked loop circuit 115, the first component and the second component may also include other hardware circuits capable of outputting clock signals. For example, the target wireless module 120 may include a circuit configured to output a clock signal for controlling wireless frame reception. Such implementations are not limited herein. Hereinafter, the phase-locked loop circuit 115 refers to a circuit arranged within the controller.

One of the first component 101 and the second component 102 is designated as a target component, and the other one is designated as a peer device. In some embodiments, the wireless frame received by the target component is not limited to being transmitted from the at least one other audio playback device 30 or the peer component. When the first component and the second component are connected to a network, the wireless frame may also originate from a network-providing device, such as a router.

In some embodiments, the receiving circuit 121, after receiving a wireless frame, may trigger the trigger circuit 122. The triggering may occur after receiving the frame header of the wireless frame, or after detecting a specific sequence or symbol within the wireless frame, or after receiving the entire wireless frame, or after a preset number of clock cycles following receipt of the wireless frame. No particular limitation is imposed herein.

According to some embodiments of the present disclosure, the receiving circuit 121, the trigger circuit 122, and the counter circuit 111 determine whether clock synchronization is required, without requiring the controller 110 to record this information through software execution. As a result, the processing load of the controller 110 may be prevented from increasing excessively, thereby reducing the burden on the controller 110 for enabling synchronization between the first component 101, the second component 102, and the at least one other audio playback device 30. In addition, the receiving circuit 121, the trigger circuit 122, and the counter circuit 111 are all hardware circuits. Compared to software-based implementations, hardware circuits provide higher stability and accuracy and are not affected by the performance of the controller 110. Accordingly, the count value obtained is less likely to be subject to errors caused by the operational state of the controller 110, and thus a more accurate count value may be acquired, which contributes to improving synchronization precision.

Additionally, compared to clock synchronization protocols, the count value output by hardware circuits offers higher precision. Therefore, after clock synchronization is performed between the first component 101, the second component 102, and the at least one other audio playback device 30 based on a synchronization protocol, the first component 101 and the second component 102 may further perform clock synchronization based on the count value. This effectively achieves a second level of synchronization within a narrower precision range. For example, while the original synchronization protocol may provide a synchronization precision of 1 ms, subsequent synchronization based on the count value may achieve precision levels such as 0.1 ms or 0.02 ms. As a result, clock synchronization based on the count value does not negatively affect the synchronized playback between the first component 101, the second component 102, and the at least one other audio playback device 30. Rather, it enhances synchronized playback of the first component 101, the second component 102, and the at least one other audio playback device 30, thereby improving user experience.

In some embodiments, the controller 110 may be configured to control the speaker 130 to play the audio data after a preset delay, following playback control synchronization adjustment. The preset delay represents a transmission time difference between: (i) the sound played by the component (the first component 101 or the second component 102) where the controller 110 is located and transmitted to a preset location, and (ii) the sound played by other audio playback devices (e.g., other audio playback devices 30 as shown in FIG. 2) and transmitted to the same preset location. The preset location is used to represent the user’s ears.

Clock synchronization refers to the synchronized playback of the same audio data among a plurality of devices based on a predetermined time. In actual scenarios, the head-mounted playback device 10 and the other playback devices (e.g., other audio playback devices 30 as shown in FIG. 2) are typically separated by a certain physical distance. Since the head-mounted playback device 10 is worn on the user’s head, while sound travels at a finite speed in air, the sound played by the head-mounted playback device 10 will reach the user’s ears earlier than sound from the other playback devices. If the same audio data is played simultaneously by both, the user may perceive an echo-like effect.

Therefore, in practical audio synchronization, it is also necessary to consider the synchronization of the time at which the sound, as played by different audio playback devices, actually reaches the user’s ears. Accordingly, in some embodiments of the present disclosure, the speaker 130 may be controlled to play the audio data after a preset delay, so as to synchronize the perceived arrival time of the audio at the user’s ears, and correct or partially correct the issue that the ears receive sound from the first component 101 and the second component 102 earlier.

In some embodiments, at least one of the first component 101 or the second component 102 may be wirelessly connected to the at least one audio playback device 30 via the target wireless module 120. The respective controllers 110 of the first component 101 and the second component 102 may be configured to: measure a target distance between the at least one audio playback device 30 and the controller 110 based on the wireless communication connection between the at least one audio playback device 30 and the component (the first component 101 or the second component 102) where the controller 110 is located; calculate a transmission time difference based on the target distance; and configure a preset delay based on the transmission time difference.

The measurement of the target distance may refer to existing wireless ranging techniques, which are not described in detail herein. The transmission time difference between (i) the sound played by the component (the first component 101 or the second component 102) where the trigger circuit 122 is located and (ii) the sound played by the other audio player and transmitted to the preset position may actually be equivalent to the transmission time of the sound between the component (the first component 101 or the second component 102) and the other audio player (e.g., other audio playback devices 30 as shown in FIG. 2). Accordingly, the preset delay may be determined as the ratio of the target distance to the speed of sound in air.

Since the distance between the first component 101 and the second component 102 of the head-mounted playback device 10 is typically small, the first component 101 and the second component 102 may be regarded as being at the same position relative to other audio playback devices (e.g., other audio playback devices 30 as shown in FIG. 2). Therefore, wireless ranging may be performed by one of the first component 101 or the second component 102, and the measured distance or corresponding preset delay may be transmitted through mutual communication between the first component 101 or the second component 102.

By performing distance measurement and configuring the preset delay based on the target distance, the head-mounted playback device 10 and other audio playback devices (e.g., other audio playback devices 30 as shown in FIG. 2) may adjust the clock synchronization time under different positional relationships. As a result, in various scenarios, the user may hear the sounds played by different audio playback devices in a relatively synchronized manner, thereby improving the effect of synchronized audio playback.

As previously described, the wireless frame may be sent by different devices and may include clock synchronization information. The clock synchronization information represents the clock of the device that sends the wireless frame. Therefore, when the wireless frame is sent by the audio source device (such as the audio source device 20 as shown in FIG. 2), the first component 101 and the second component 102 of the head-mounted playback device 10 are synchronized based on the clock of the audio source device. Similarly, when the wireless frame is sent by a router device, the first component 101 and the second component 102 are synchronized based on the clock of the router device. When the wireless frame received by a target component among the first component 101 and the second component 102 is transmitted by the peer component, the target component is synchronized based on the clock of the peer component. Here, the target component refers to one of the first component 101 and the second component 102, and the peer component refers to the other component that is not the target component.

In some embodiments, when the wireless frame is sent by the audio source device (such as the audio source device 20 as shown in FIG. 2) or a router device, the target wireless module (120 as shown in FIG. 1 or 320 as shown in FIG. 3) may be a Wi-Fi module, the wireless frame may include a Wi-Fi beacon frame, and the receiving circuit 121 or 321 may be a Wi-Fi beacon frame receiving sub-circuit. The first component 101, the second component 102, and the at least one other playback device 30 may be communicatively connected to the audio source device or the router device via the Wi-Fi module and may receive the Wi-Fi beacon frame sent by the audio source device or the router device via the Wi-Fi beacon frame receiving sub-circuit. The Wi-Fi beacon frame receiving sub-circuit may trigger the trigger circuit 122 or 322 within the corresponding first component 101, second component 102, or the at least one other playback device after receiving the Wi-Fi beacon frame. Other circuits of the Wi-Fi module may refer to the related technology, and the target wireless module used in embodiments of the present disclosure may be implemented by configuring the receiving circuit and the trigger circuit based on an existing Wi-Fi module.

In addition, when the wireless frame is sent by the audio source device (e.g., the audio source device 20 as shown in FIG. 2), the audio data to be played may be carried in the wireless frame, i.e., the wireless frame may include both clock synchronization information and the audio data to be played.

Correspondingly, the receiving circuit 121 or 321 may receive the Wi-Fi beacon frame based on a clock signal output by the phase-locked loop circuit 115 or 315. When the wireless frame received by the receiving circuit 121 includes a Wi-Fi beacon frame, the receiving circuit 121 or 321 may detect the Wi-Fi beacon frame within the wireless frame and then trigger the trigger circuit 122 or 322.

In some embodiments, the first component 101, the second component 102, and the at least one other playback device may be communicatively connected to the audio source device (e.g., the audio source device 20 as shown in FIG. 2) via DLNA (Digital Living Network Alliance), Airplay (a wireless streaming protocol for audio, video, or photos), or a Wi-Fi direct connection protocol. No particular limitation is imposed herein.

In some embodiments, when the wireless frame includes a Wi-Fi beacon frame, the clock synchronization information may be a Time Synchronization Function (TSF) value included in the Wi-Fi beacon frame.

In some embodiments, the controllers 110 of both the first component 101 and the second component 102 may be configured to: compare the count value with the TSF value in the Wi-Fi beacon frame; and, adjust, when the count value and the TSF value indicate that the clocks are not synchronized, the phase-locked loop circuit 115 based on a difference between the count value and the TSF value, such that the clock signal output by the phase-locked loop circuit 115 matches a clock signal of the device that sends the wireless frame.

The counter circuit 111 may perform counting based on a clock signal output by the phase-locked loop circuit 115, and the TSF value may also be based on a count value generated by a counter of the audio source device or the router device. Therefore, the count value and the TSF value may be directly compared to determine whether the count value and the TSF value match, and thereby determine whether the clocks are synchronized. Compared with comparing clock signals, comparing the count value with the TSF value may improve comparison efficiency and reduce power consumption required to determine clock synchronization. The term “match” may refer to the count value and the TSF value being equal, or to the difference between the count value and the TSF value being within a predetermined threshold, which is not limited herein.

By comparing the count value with the TSF value, it may be determined whether the clock signal output by the phase-locked loop circuit 115 of the first component 101 or the second component 102 is synchronized. When the clock signals are not synchronized, the phase-locked loop circuit 115 may be adjusted such that the output clock signal outputted by the phase-locked loop circuit 115 accelerates or decelerates the counting of the counter circuit 111, until the counter circuit 111 matches the TSF value in the Wi-Fi beacon frame, thereby achieving synchronization between the clock signal output by the phase-locked loop circuit 115 and the TSF value in the Wi-Fi beacon frame. The methods for adjusting the phase-locked loop circuit 115 to change the output clock signal may refer to conventional techniques and is not described in detail herein.

In some embodiments, the counter circuit 111 performs counting based on a clock signal generated by the first component 101 or the second component 102, and the count value of the counter circuit 111 may be used to characterize the clock signal. Therefore, the controllers 110 of the first component 101 and the second component 102 may be configured not to control the playback of the audio data based on the clock signal output by the phase-locked loop circuit 115, but instead to control the speaker 130 to play the audio data to be played based on the count value of the counter circuit 111.

In some embodiments, the controller 110 may further be configured to: compare the count value with the TSF value of the Wi-Fi beacon frame; and when the count value and the TSF value indicate that the clocks are not synchronized, adjust both a total value of the counter circuit 111 and an accumulated value of the counter circuit 111 per clock cycle based on a difference between the count value and the TSF value as clock synchronization information, such that the total value of the counter circuit 111 matches the TSF value, thereby ensuring that the clock signal characterized by the count value output by the counter circuit 111 matches the clock signal characterized by the TSF value.

The term “match” refers to the count value and the TSF value being identical or having a difference within a predetermined threshold. When the count value and the TSF value indicate that the clocks are not synchronized, the count value and the TSF value are considered not to match. In some embodiments, adjusting the total value of the counter circuit 111 based on the difference between the count value and the TSF value as clock synchronization information may include: calculating a difference between the current count value acquired by the trigger circuit 122 and the TSF value, and then adding the corresponding difference to the total value of the counter circuit 111. This approach does not require adjustment of the phase-locked loop circuit 115 that outputs the clock signal, thereby further reducing implementation complexity and lowering power consumption.

In some embodiments, the wireless frame may also be transmitted between the first component 101 and the second component 102. That is, the first component 101 may transmit a wireless frame to the second component 102, or the second component 102 may transmit a wireless frame to the first component 101. This approach is performed by establishing a communication connection between the first component 101 and the second component 102.

In some embodiments, the target wireless module 120 is a Bluetooth module or a Wi-Fi module, and the first component 101 and the second component 102 may be communicatively connected via Bluetooth or Wi-Fi. The receiving circuit 121 may include a Bluetooth frame receiving sub-circuit, and the wireless frame may include a Bluetooth frame.

The target wireless module 120 of the target component may be configured to receive the Bluetooth frame transmitted by the peer component through the Bluetooth frame receiving sub-circuit. Clock synchronization information included in the Bluetooth frame transmitted by the peer component may include a peer count value of the peer component. The controller 110 of the target component may be configured to: receive a target count value output by the target wireless module 120 of the target component; compare the target count value with the peer count value; and perform playback control synchronization adjustment based on a difference between the target count value and the peer count value. Here, one of the first component 101 or the second component 102 serves as the target component, and the other one serves as the peer component. The peer component may transmit its own count value to the target component, such that the target component is synchronized with the peer component.

In some embodiments, synchronization may be achieved by adjusting the clock signal output by the phase-locked loop circuit 115. For example, the controller 110 of the target component may be configured to adjust the phase-locked loop circuit 115 based on a difference between the target count value and the peer count value, so as to synchronize the playback control of the target component with that of the peer component.

In some embodiments, the controller 110 of the target component may further be configured to adjust a playback timing of the audio data to be played by the target component based on the difference between the target count value and the peer count value, so as to synchronize the playback control of the target component with the playback control of the peer component.

The audio data to be played may first be stored in a buffer and then output from the buffer to the speaker 130 for playback. In some embodiments, the amount of data stored in the buffer may be adjusted so as to adjust the playback timing of the audio data to be played.

The above-mentioned synchronization between the first component 101, the second component 102, and the at least one other audio playback device 30 are merely examples provided by the present disclosure. Different synchronization manners may be selected in different scenarios without limitation.

Yet another aspect of the present disclosure provides a method for synchronizing audio playback in a head-mounted playback device. The method may be applied to the head-mounted playback device 10 provided in any of the foregoing embodiments.

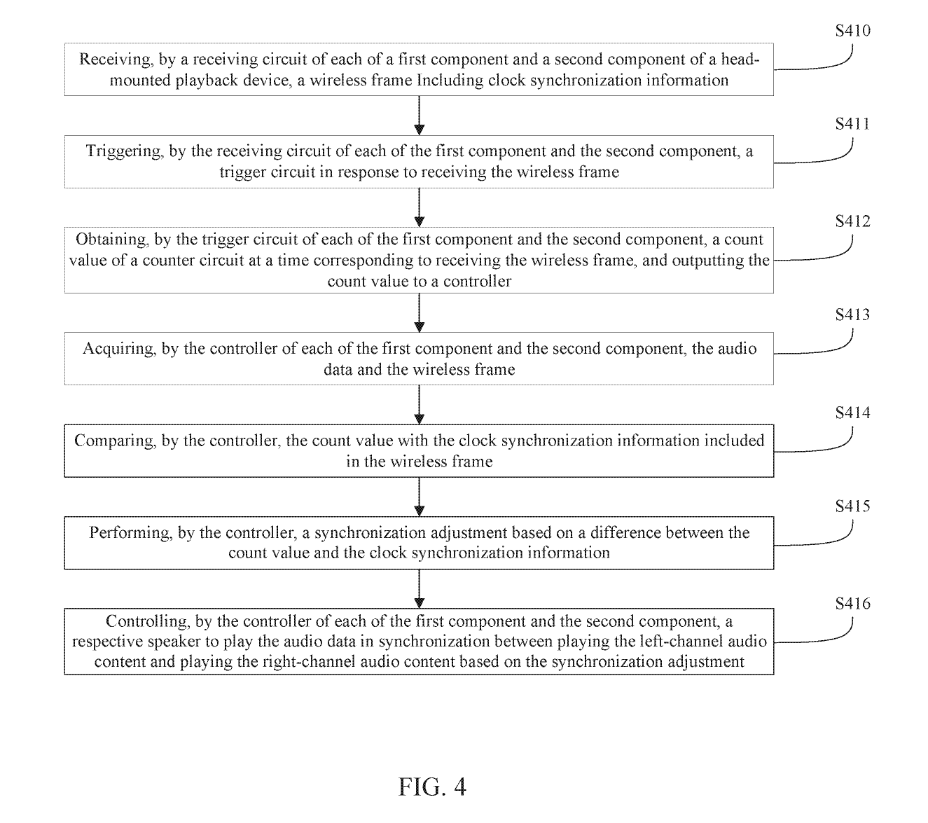

Refer to FIG. 4, which illustrates a flowchart of a method for synchronizing audio playback according to some embodiments of the present disclosure. The method includes the following.

S410: Receiving, by a receiving circuit of a target wireless module of each of a first component and a second component of a head-mounted playback device, a wireless frame including clock synchronization information. For example, the wireless frame is received by a receiving circuit (e.g., the receiving circuit 121 as shown in FIG. 1) of a target wireless module (e.g., the target wireless module 120) of a first component or a second component of a head-mounted playback device (e.g., first component 101 or second component 102 of head-mounted playback device 10 as shown in FIG. 1).

S411. Triggering, by the receiving circuit, a trigger circuit in response to receiving the wireless frame. For example, after receiving the wireless frame, the receiving circuit 121 triggers the trigger circuit 122 as shown in FIG. 1, and outputs the count value to the controller 110 as shown in FIG. 1.

S412. Obtaining, by the trigger circuit of each of the first component and the second component, a count value of a counter circuit at a time corresponding to receiving the wireless frame, and outputting the count value to a controller. For example, the trigger circuit 122, once being triggered, obtains the current count value of counter circuit 111 as shown in FIG. 1.

S413. Acquiring, by the controller of each of the first component and the second component, the audio data and the wireless frame. For example, the controller 110 of each of the first component 101 and the second component 102 acquire the audio data and the wireless frame.

S414. Comparing, by the controller, the count value with the clock synchronization information included in the wireless frame. For example, the controller 110 of each of the first component 101 and the second component 102 compares the count value with the clock synchronization information in the wireless frame.

S415. Performing, by the controller, a synchronization adjustment based on a difference between the count value and the clock synchronization information. For example, the controller 110 of each of the first component 101 and the second component 102 performs a synchronization adjustment based on a difference between the count value and the clock synchronization information.

S416. Controlling, by the controller of each of the first component and the second component, a respective speaker to play the audio data in synchronization between playing the left-channel audio content and playing the right-channel audio content based on the synchronization adjustment. For example, the controller 110 of each of the first component 101 and the second component 102 controllers a respective speaker 130 to play the audio data in synchronization between playing left-channel audio and right-channel audio contents.

In some embodiments, the clock synchronization information in the wireless frame includes a timing synchronization function (TSF) value. Receiving the wireless frame includes: receiving a Wi-Fi beacon frame by a Wi-Fi module, which may involve receiving, by a Wi-Fi beacon frame receiving sub-circuit, the Wi-Fi beacon frame and triggering the trigger circuit in response to receiving the Wi-Fi beacon frame.

In some embodiments, the controller (e.g., each controller 110 of the first component 101 and the second component 102 as shown in FIG. 1) includes a phase-locked loop circuit (e.g., the phase-locked loop circuit 115 as shown in FIG. 1) connected to the counter circuit (e.g., the counter circuit 111 as shown in FIG. 1). The method further includes: controlling playback of the audio data based on a clock signal output by the phase-locked loop circuit; performing counting, by the counter circuit, based on the clock signal output by the phase-locked loop circuit; comparing, by the phase-locked loop circuit, the count value with the TSF value in the Wi-Fi beacon frame; and adjusting, by the phase-locked loop circuit, the output clock signal based on a difference between the count value and the TSF value, such that the output clock signal matches a clock signal of a device that sends the wireless frame.

In some embodiments, the method further includes: controlling, by each controller, the speaker (e.g., speaker 130 as shown in FIG. 1) to play the audio data based on the count value of the counter circuit; comparing, by each controller, the count value with the TSF value of the Wi-Fi beacon frame; and adjusting, by each controller, both a total value of the counter circuit and an accumulated value of the counter circuit per clock cycle based on the difference between the count value and the TSF value, such that the total value of the counter circuit matches the TSF value.

In some embodiments, the target wireless module is a Bluetooth module or a Wi-Fi module, or other modules that enable wireless communications. For example, the first component and the second component are communicatively connected via Bluetooth or Wi-Fi. The receiving circuit includes a Bluetooth frame receiving sub-circuit, and the wireless frame includes a Bluetooth frame. The method further includes: receiving, by a target wireless module of a target component, the Bluetooth frame sent by a peer component via the Bluetooth frame receiving sub-circuit, wherein the target component is one of the first component or the second component, and the peer component is the other one of the first component or the second component, and clock synchronization information in the Bluetooth frame sent by the peer component includes a peer count value of the peer component; receiving, by a controller of the target component, a target count value output by the target wireless module of the target component; comparing, by the controller of the target component, the target count value with the peer count value; and performing, by the controller of the target component, playback control synchronization based on a difference between the target count value and the peer count value.

In some embodiments, the phase-locked loop circuit is connected to the target wireless module, and the method further includes: controlling playback of the audio data based on a clock signal output by the phase-locked loop circuit; counting, by the counter circuit, based on the clock signal output by the phase-locked loop circuit; and adjusting, by the controller of the target component, the phase-locked loop circuit based on a difference between the target count value and the peer count value, such that a clock signal output by the adjusted phase-locked loop circuit enables playback control synchronization between the target component and the peer component.

Yet another aspect of the present disclosure provides a method for synchronizing audio playback in an audio playback system. The method may be applied to the audio playback system 200 provided in any of the foregoing embodiments.

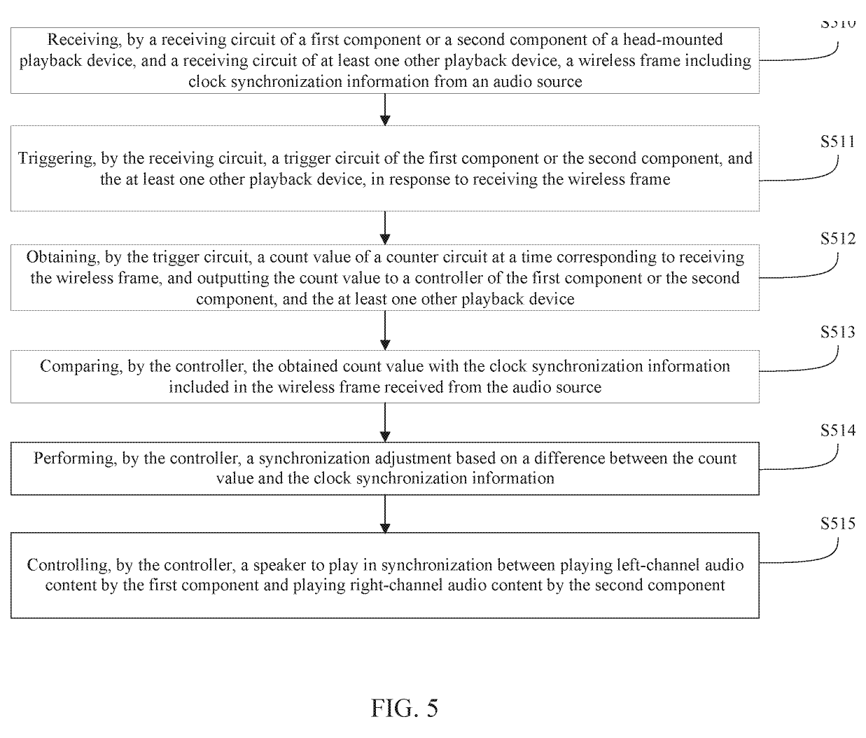

Refer to FIG. 5, which illustrates a flowchart of a method for synchronizing audio playback in an audio playback system according to some embodiments of the present disclosure. The method includes the following.

S510. Receiving, by a receiving circuit of each of a first component and/or a second component of a head-mounted playback device, and a receiving circuit of at least one other playback device, a wireless frame including clock synchronization information from an audio source. For example, the wireless frame from the audio source device (e.g., the at least one other audio playback device 20 as shown in FIG. 2) is received by a receiving circuit (e.g., the receiving circuit 121 as shown in FIG. 1 or the receiving circuit 312 as shown in FIG. 3) of a target wireless module (e.g., the target wireless module 120 as shown in FIG. 1 or 310 as shown in FIG. 3).

S511. Triggering, by the receiving circuit, a trigger circuit in response to receiving the wireless frame. For example, after receiving the wireless frame, the receiving circuit 121 or 321 triggers the trigger circuit (122 as shown in FIG. 1 or 321 as shown in FIG. 3).

S512. Obtaining, by the trigger circuit, a count value of a counter circuit at a time corresponding to receiving the wireless frame, and outputting the count value to a controller. For example, the trigger circuit 122, once being triggered, obtains the current count value of counter circuit 111 as shown in FIG. 1, and outputs the count value to the controller 110 as shown in FIG. 1.

S513. Comparing, by the controller, the obtained count value with the clock synchronization information included in the wireless frame received from the audio source. For example, the controller 110 of the first component 101, the second component 102 as shown in FIG. 1, and the at least one other playback device 30 as shown in FIG. 3 compares the obtained count value with the clock synchronization information included in the wireless frame received from the audio source device 20 as shown in FIG. 2.

S514. Performing, by the controller, a synchronization adjustment based on a difference between the count value and the clock synchronization information. For example, the controller 110 of the first component 101 and/or the second component 102 as shown in FIG. 1, as well as the controller 310 of the at least one other playback device 30 performs the synchronization adjustment based on the difference between the count value and the clock synchronization information.

S515. controlling, by the controller, the speaker to play in synchronization between playing left-channel audio content by the first component and playing right-channel audio content by the second component based on the synchronization adjustment.

For example, the controller 110 of the first component 101 and/or the second component 102 control a respective speaker 130 to play audio data, such that sound from the first component 101, the second component 102, and the at least one other audio playback device 30 to arrive at the user's ear substantially simultaneously regardless of user movement or changes in the relative position of the devices.

In some embodiments, performing the synchronization adjustment includes: performing, by at least one of the first component 101 or the second component 102 and the at least one other audio playback device 30, synchronization based on a same clock synchronization protocol, and controlling their respective speaker to play in synchronization includes: synchronously playing, by at least one of the first component or the second component and the at least one other audio playback device, based on a same synchronized clock. In some embodiments, the method further includes: synchronously playing, by at least one of the first component 101 or the second component 102 and the at least one other audio playback device 30, based on a same synchronized clock.

In some embodiments, the synchronization mechanism employed by the at least one other audio playback device 30 may be the same as the synchronization mechanism implemented by the first component 101 and/or the second component 102, since the at least one other audio playback device 30 includes similar components, such as a trigger circuit, a counter circuit, a controller, etc. Accordingly, the at least one other audio playback device 30 is capable of achieving synchronized playback with the first component 101 and/or the second component 102 based on the same synchronization protocol or mechanism.

In some embodiments, the controller 110 of the first component 101 and/or the second component 102 determine, based on relative positions of the first component and/or the second component with respect to the at least one other audio playback device 30, a dynamic playback delay to be applied to playback timing of the speaker of the first component or the second component. For example, the dynamic playback delay corresponds to a transmission time for sound emitted by the at least one other audio playback device 30 to reach a predetermined location associated with the head-mounted playback device 10. When the head-mounted playback device 10 is worn by a user, its position closely corresponds to the position of the user’s ears. The controller 110 of the first component 101 or the second component 102 may utilize signals exchanged between the head-mounted playback device 10 and the at least one other audio playback device 30 to measure the distance between the head-mounted playback device 10 and the at least one other audio playback device 30. The controller 110 may then dynamically adjust the playback delay in response to changes in the user’s location.

In some embodiments, the method further includes: maintaining the dynamic synchronization by continuously or periodically adjusting, by the controller of at least one of the first component 101 or the second component 102, the dynamic playback delay of the speaker of the first component or the second component in response to changes in the relative position of the first component or the second component with respect to the at least one other audio playback device.

In some embodiments, the method further includes: controlling, by the controller of at least one of the first component or the second component, the speaker to play the audio data after applying the dynamic playback delay, where the dynamic playback delay corresponds to a transmission time for sound emitted by the at least one other audio playback device to reach a predetermined location associated with the head-mounted playback device, such that audio from both the head-mounted playback device and the at least one other audio playback device arrives at a user's ear substantially simultaneously.

In some embodiments, the method further includes: wirelessly connecting at least one of the first component or the second component and the at least one other audio playback device; performing, by the controller of at least one of the first component or the second component, a measurement of a target distance between one of the first component or the second component and the at least one other audio playback device based on a wireless communication connection; calculating, by the controller, a transmission time based on the target distance; and determining, by the controller, the dynamic playback delay based on the transmission time.

In some embodiments, the wirelessly connecting the at least one of the first component or the second component and the at least one other audio playback device includes: connecting via a Digital Living Network Alliance (DLNA) protocol, an AirPlay protocol, or a Wi-Fi direct connection protocol.

In some embodiments, at least one of a first component (e.g., first component 101 as shown in FIG. 1) or a second component (e.g., second component 102 as shown in FIG. 1) of the head-mounted playback device may be wirelessly communicatively connected to another audio playback device via a target wireless module (e.g., target wireless module 120 as shown in FIG. 1). Prior to acquiring the audio data to be played, the wireless frame, and the count value, the method may further include: measuring a target distance between the first component, the second component, and the other audio playback device based on the wireless communication connection; calculating a transmission time difference based on the target distance; and configuring a preset delay based on the transmission time difference.

In some embodiments, the target wireless module is a Wi-Fi module, the wireless frame includes a Wi-Fi beacon frame, and the clock synchronization information is a timing synchronization function (TSF) value. The receiving circuit is a Wi-Fi beacon frame receiving sub-circuit. The Wi-Fi beacon frame receiving sub-circuit is configured to: receive the Wi-Fi beacon frame and trigger the trigger circuit upon receiving the Wi-Fi beacon frame. Receiving the wireless frame includes receiving the Wi-Fi beacon frame. Performing the synchronization adjustment includes: performing the synchronization adjustment based on the count value and the TSF value.

In some embodiments, the controllers of both the first component and the second component include a phase-locked loop circuit (e.g., the phase-locked loop circuit 115 as shown in FIG. 1). Each of the first component and the second component is configured such that: the phase-locked loop circuit is connected to a counter circuit (e.g., the counter circuit as shown in FIG. 1); the controller controls playback of the audio data to be played based on a clock signal output by the phase-locked loop circuit; the receiving circuit receives the Wi-Fi beacon frame based on the clock signal output by the phase-locked loop circuit; and the counter circuit performs counting based on the clock signal output by the phase-locked loop circuit. Performing synchronization adjustment includes: comparing the count value with the TSF value included in the Wi-Fi beacon frame; and when the count value and the TSF value indicate that the clocks are not synchronized, adjusting the phase-locked loop circuit based on a difference between the count value and the TSF value, such that the clock signal output by the phase-locked loop circuit matches a clock signal of the device that transmitted the wireless frame.

In some embodiments, performing synchronization adjustment includes: comparing the count value with the TSF value of the Wi-Fi beacon frame; and when the count value and the TSF value indicate that the clocks are not synchronized, adjusting a total value of the counter circuit and an accumulated value of the counter circuit per clock cycle based on a difference between the count value and the TSF value, such that the total value of the counter circuit matches the TSF value. The method further includes controlling the speaker to play the audio data to be played based on the count value of the counter circuit.

In some embodiments, the target wireless module is a Bluetooth module or a Wi-Fi module. The first component and the second component are communicatively connected via Bluetooth or Wi-Fi. The receiving circuit includes a Bluetooth frame receiving sub-circuit, and the wireless frame includes a Bluetooth frame.

The target wireless module of a target component is configured to receive a Bluetooth frame sent by a peer component via the Bluetooth frame receiving sub-circuit. The clock synchronization information included in the Bluetooth frame sent by the peer component includes a peer count value of the peer component. The target component is one of the first component or the second component, while the peer component is the other one of the first component or the second component. The method further includes: receiving a target count value; comparing the target count value with the peer count value; and performing playback control synchronization adjustment based on a difference between the target count value and the peer count value.

In some embodiments, performing synchronization adjustment includes: adjusting, when the target count value and the peer count value indicate that the clocks are not synchronized, the phase-locked loop circuit based on a difference between the target count value and the peer count value, such that playback control of the target component is synchronized with playback control of the peer component based on a clock signal output by the adjusted phase-locked loop circuit.

In some embodiments, performing synchronization adjustment includes: adjusting a playback timing of the audio data to be played at the target component based on a difference between the target count value and the peer count value, such that playback control of the target component is synchronized with that of the peer component.

In embodiments of the present disclosure, it should be understood that the disclosed method may also be implemented in other ways. The functional modules described in various embodiments of the present disclosure may be integrated to form a single unit, or each module may exist independently, or two or more modules may be integrated into a single unit.

The above embodiments may be freely combined, provided that there is no conflict among them. Any embodiment formed by such combinations shall fall within the scope of protection of the present disclosure.

The detailed description of embodiments of the present disclosure along with accompanying drawings is not intended to limit the scope of the present disclosure. All other embodiments obtained by those of ordinary skill in the art without creative work, based on the embodiments disclosed herein, shall fall within the scope of protection of the present disclosure.

It should be noted that similar reference numerals and letters in the drawings denote similar elements. Once an element is defined in one figure, it does not require further definition or explanation in subsequent figures.

In the description of the present disclosure, unless expressly specified or limited otherwise, the term “connected” should be interpreted broadly, including, for example, fixed connection, removable connection, integral connection, electrical connection, direct connection, or indirect connection via an intermediate medium, or communication between internal elements. Those of ordinary skill in the art will understand the specific meanings of such terms based on the context.

The above description merely illustrates exemplary embodiments of the present disclosure and is not intended to limit the scope of protection. Those skilled in the art may make various modifications and variations to the present disclosure. Any modification, equivalent substitution, or improvement made within the spirit and scope of the present disclosure shall fall within the protection scope thereof.

What is claimed is:

1. A head-mounted playback device, comprising:
a first component configured to playback left-channel audio content of audio data; and
a second component configured to playback right-channel audio content of the audio data,
wherein each of the first component and the second component comprises:
a controller comprising a counter circuit;
a target wireless module comprising a receiving circuit and a trigger circuit; and
a speaker, wherein:
the receiving circuit is configured to: receive a wireless frame including clock synchronization information, and trigger the trigger circuit upon receiving the wireless frame;
the trigger circuit, upon being triggered, is configured to: obtain a count value of the counter circuit, and output the count value to the controller; and
the controller is configured to: acquire audio data and the wireless frame, compare the count value of the counter circuit with the clock synchronization information included in the wireless frame, perform a synchronization adjustment based on a difference between the count value and the clock synchronization information, and control the speaker to play the audio data in synchronization between playing the left-channel audio content and playing the right-channel audio content based on the synchronization adjustment.

2. The head-mounted playback device according to claim 1, wherein
the target wireless module is a Wi-Fi module;
the wireless frame comprises a Wi-Fi beacon frame;
the clock synchronization information comprises a timing synchronization function (TSF) value; and
the receiving circuit comprises a Wi-Fi beacon frame receiving sub-circuit configured to receive the Wi-Fi beacon frame, and trigger the trigger circuit upon receiving the Wi-Fi beacon frame.

3. The head-mounted playback device according to claim 2, wherein
the controller comprises a phase-locked loop circuit that is connected to the counter circuit;
the controller controls playback of the audio data based on a clock signal output by the phase-locked loop circuit;
the counter circuit performs counting based on the clock signal output by the phase-locked loop circuit; and
the phase-locked loop circuit is configured to compare the count value with the TSF value in the Wi-Fi beacon frame, and adjust the phase-locked loop circuit based on a difference between the count value and the TSF value, such that the clock signal output by the phase-locked loop circuit matches a clock signal of a device that sends the wireless frame.

4. The head-mounted playback device according to claim 3, wherein each controller of the first component and the second component is configured to:
control the speaker to play the audio data based on the count value of the counter circuit; and
compare the count value with the TSF value of the Wi-Fi beacon frame, and adjust both a total value of the counter circuit and an accumulated value of the counter circuit per clock cycle based on the difference between the count value and the TSF value, such that the total value of the counter circuit matches the TSF value.

5. The head-mounted playback device according to claim 1, wherein
the target wireless module comprises a Bluetooth module, and the first component and the second component are communicatively connected via Bluetooth;
the receiving circuit comprises a Bluetooth frame receiving sub-circuit, and the wireless frame comprises a Bluetooth frame;
the target wireless module of a target component is configured to receive the Bluetooth frame sent by a peer component via the Bluetooth frame receiving sub-circuit; and
clock synchronization information in the Bluetooth frame sent by the peer component comprises a peer count value of the peer component, wherein
the target component is one of the first component or the second component, and the peer component is the other one of the first component or the second component; and
the controller of the target component is configured to: receive a target count value output by the target wireless module of the target component, compare the target count value with the peer count value, and perform playback control synchronization based on a difference between the target count value and the peer count value.

6. The head-mounted playback device according to claim 5, wherein the controller comprises a phase-locked loop circuit connected to the target wireless module, wherein
the controller is configured to control playback of the audio data based on a clock signal output by the phase-locked loop circuit;
the counter circuit is configured to count based on the clock signal output by the phase-locked loop circuit; and
the controller of the target component is configured to: adjust the phase-locked loop circuit based on the difference between the target count value and the peer count value, such that a clock signal output by the adjusted phase-locked loop circuit enables playback control synchronization between the target component and the peer component.

7. The head-mounted playback device according to claim 5, wherein the controller of the target component is configured to:
adjust a playback timing of the audio data by the target component based on the difference between the target count value and the peer count value; and
perform playback control synchronization between the target component and the peer component.

8. An audio playback system, comprising:
a head-mounted playback device and at least one other audio playback device, wherein the head-mounted playback device comprises a first component configured to playback left-channel audio content of audio data and a second component configured to playback right-channel audio content of audio data, each of the first component and the second component comprising:
a controller comprising a counter circuit;
a target wireless module comprising a receiving circuit and a trigger circuit; and
a speaker, wherein
the receiving circuit is configured to: receive a wireless frame comprising clock synchronization information from an audio source, and trigger the trigger circuit upon receiving the wireless frame;
the trigger circuit, upon being triggered, is configured to obtain a count value of the counter circuit, and output the count value to the controller; and
each controller of the first component or the second component is configured to:
compare the count value of the counter circuit with the clock synchronization information included in the wireless frame received from the audio source;
perform a synchronization adjustment based on a difference between the count value and the clock synchronization information; and
control the speaker to play in synchronization between playing the left-channel audio content by the first component, and playing the right-channel audio content by the second component based on the synchronization adjustment.

9. The audio playback system according to claim 8, wherein at least one of the first component or the second component and the at least one other audio playback device are configured to perform synchronization based on a same clock synchronization protocol; and
at least one of the first component or the second component and the at least one other audio playback device are configured to synchronously play the audio data based on a same synchronized clock.

10. The audio playback system according to claim 8, wherein each controller of the first component or the second component is further configured to:
determine, based on relative positions of the first component or the second component with respect to the at least one other audio playback device, a dynamic playback delay to be applied to playback timing of the speaker; and
control the speaker to play audio data in dynamic synchronization with the at least one other audio playback device based on the synchronization adjustment and the dynamic playback delay.

11. The audio playback system according to claim 10, wherein each controller of the first component or the second component is configured to maintain the dynamic synchronization by continuously or periodically adjusting the dynamic playback delay of the speaker in response to changes in the relative positions between the first component and the at least one other audio playback device or between the second component and the at least one other audio playback device.

12. The audio playback system according to claim 11, wherein each controller of the first component or the second component is further configured to control the speaker playing the audio data after applying the dynamic playback delay,
wherein the dynamic playback delay corresponds to a transmission time for sound emitted by the at least one other audio playback device to reach a predetermined location associated with the head-mounted playback device, such that audio from both the head-mounted playback device and the at least one other audio playback device arrives at a user's ears substantially simultaneously.

13. The audio playback system according to claim 12, wherein
at least one of the first component or the second component and the at least one other audio playback device are wirelessly connected to the audio source via the target wireless module; and
each controller of the first component or the second component is configured to:
perform measurement of a target distance between the first component and the at least one other audio playback device based on a wireless communication connection between the first component and the at least one other audio playback device, or perform measurement of a target distance between the second component and the at least one other audio playback device based on a wireless communication connection between the second component and the at least one other audio playback device;
calculate the transmission time based on the target distance; and
determine the dynamic playback delay based on the transmission time.

14. The audio playback system according to claim 8, wherein the first component, the second component, or the at least one other audio playback device is connected to the audio source via a Digital Living Network Alliance (DLNA) protocol, an AirPlay protocol, or a Wi-Fi direct connection protocol.

15. The audio playback system according to claim 8, wherein
the target wireless module is a Wi-Fi module;
the wireless frame comprises a Wi-Fi beacon frame;
the clock synchronization information comprises a timing synchronization function (TSF) value; and
the receiving circuit comprises a Wi-Fi beacon frame receiving sub-circuit,
wherein the Wi-Fi beacon frame receiving sub-circuit is configured to receive the Wi-Fi beacon frame, and trigger the trigger circuit upon receiving the Wi-Fi beacon frame.

16. The audio playback system according to claim 15, wherein
the controller comprises a phase-locked loop circuit that is connected to the counter circuit;
the controller controls playback of the audio data based on a clock signal output by the phase-locked loop circuit;
the counter circuit performs counting based on the clock signal output by the phase-locked loop circuit; and
the controller is configured to compare the count value with the TSF value in the Wi-Fi beacon frame, and adjust the phase-locked loop circuit based on a difference between the count value and the TSF value, such that the clock signal output by the phase-locked loop circuit matches a clock signal of the audio source that sends the wireless frame.

17. The audio playback system according to claim 16, wherein each controller of the first component and the second component is configured to:
control the speaker to play the audio data based on the count value of the counter circuit; and
compare the count value with the TSF value of the Wi-Fi beacon frame, and adjust both a total value of the counter circuit and an accumulated value of the counter circuit per clock cycle based on the difference between the count value and the TSF value, such that the total value of the counter circuit matches the TSF value.

18. A method for synchronizing audio playback in a head-mounted playback device, wherein the head-mounted playback device comprises a first component configured to playback left-channel audio content of audio data and a second component configured to playback right-channel audio content of the audio data, the method comprising:
receiving, by a receiving circuit of a target wireless module of each of the first component and the second component, a wireless frame comprising clock synchronization information;
triggering, by the receiving circuit, a trigger circuit of the target wireless module in response to receiving the wireless frame;
obtaining, by the trigger circuit of each of the first component and the second component, a count value of a counter circuit at a time corresponding to receiving the wireless frame, and outputting the count value to a controller;
acquiring, by the controller of each of the first component and the second component, the audio data and the wireless frame;
comparing, by the controller, the count value with the clock synchronization information included in the wireless frame;
performing, by the controller, a synchronization adjustment based on a difference between the count value and the clock synchronization information; and
controlling, by the controller of each of the first component and the second component, a respective speaker to play the audio data in synchronization between playing the left-channel audio content and playing the right-channel audio content based on the synchronization adjustment.

19. The method according to claim 18, wherein the clock synchronization information included in the wireless frame comprises a timing synchronization function (TSF) value, and receiving the wireless frame comprises:
receiving a Wi-Fi beacon frame by a Wi-Fi module; and
wherein receiving the Wi-Fi beacon frame comprises:
receiving, by a Wi-Fi beacon frame receiving sub-circuit, the Wi-Fi beacon frame and triggering the trigger circuit in response to receiving the Wi-Fi beacon frame.

20. The method according to claim 19, wherein the controller comprises a phase-locked loop circuit connected to the counter circuit, the method further comprising:
controlling playback of the audio data based on a clock signal output by the phase-locked loop circuit;
performing counting, by the counter circuit, based on the clock signal output by the phase-locked loop circuit;
comparing, by the controller, the count value with the TSF value in the Wi-Fi beacon frame; and
adjusting, by the phase-locked loop circuit, the output clock signal based on a difference between the count value and the TSF value, such that the output clock signal matches a clock signal of a device that sends the wireless frame.
